(19) United States
(12) Patent Application Publication
(10) Pub. No.: US 2017/0058389 A1
(43) Pub. Date: Mar. 2, 2017

(54) LITHIUM BATTERY FABRICATION PROCESS USING MULTIPLE ATMOSPHERIC PLASMA NOZZLES

(71) Applicants: Jianyong LIU, Shanghai (CN); GM GLOBAL TECHNOLOGY OPERATIONS LLC, DETROIT, MI (US)

(72) Inventors: Xiaohong Q. Gayden, West Bloomfield, MI (US); Jianyong Liu, Shanghai (CN); Zhiqiang Yu, Shanghai (CN); Haijing Liu, Shanghai (CN); Qiang Wu, Shanghai (CN)

(21) Appl. No.: 15/308,860

(22) PCT Filed: May 12, 2014
(86) PCT No.: PCT/CN2014/077211

§ 371 Date: Nov. 4, 2016

(51) Int. Cl. C23C 4/134; H01M 10/0525; C23C 4/11; H01M 4/04; H01M 4/62; H01M 4/133; H01M 4/134; H01M 4/131; C23C 4/06; H01M 4/66

(52) U.S. Cl. CPC C23C 4/134; C23C 4/06; H01M 10/0525; C23C 4/11; H01M 4/661; H01M 4/621; H01M 4/626; H01M 4/133; H01M 4/134; H01M 4/131; H01M 4/0419; H01M 2220/20

(57) ABSTRACT

A first atmospheric plasma producing nozzle is used to direct a gas-borne stream of plasma heated and activated particles of lithium battery electrode material for deposition on a surface of lithium cell member, such as a separator or current collector foil. A second atmospheric plasma producing nozzle is used to direct a gas-borne stream of plasma heated and activated metal particles at the same surface area being coated with the stream of electrode material particles. The two plasma streams are combined at the cell member surface to form a layer of electrically-conductive metal-bonded particles of electrode material. The use of multiple atmospheric plasma streams is useful in making thin, efficient, and lower cost electrode structures for lithium batteries.

### TECHNICAL FIELD

This disclosure pertains to methods of using a grouping of atmospheric plasma nozzles to make electrode members for lithium secondary battery cells. Active material particles for lithium-ion cell electrode members, for example, are co-deposited with smaller particles of elemental metals as layers of electrode members by using two or more atmospheric plasma guns in efficient manufacturing steps to form combinations of anode, cathode, and separator members for battery cells. The use of multiple plasma nozzles, operated at selected different plasma energy levels, to co-deposit a variety of electrode materials and metal binder/conductor materials, enables manufacture of thinner, lower weight, and more electrochemically efficient lithium-ion and lithium-sulfur cell members.

### BACKGROUND OF THE INVENTION

Assemblies of lithium-ion battery cells are finding increasing applications in providing motive power in automotive vehicles. Lithium-sulfur cells are also candidates for such applications. Each lithium-ion cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

In these automotive applications, each lithium-ion cell typically comprises a negative electrode layer (anode, during cell discharge), a positive electrode layer (cathode, during cell discharge), a thin porous separator layer interposed in face-to-face contact between parallel, facing, electrode layers, and a liquid, lithium-containing, electrolyte solution filling the pores of the separator and contacting the facing surfaces of the electrode layers for transport of lithium ions during repeated cell discharging and re-charging cycles. Each electrode is prepared to contain a layer of an electrode material, typically deposited as a wet mixture on a thin layer of a metallic current collector.

For example, the negative electrode material has been formed by depositing a thin layer of graphite particles, often mixed with conductive carbon black, and a suitable polymeric binder onto one or both sides of a thin foil of copper which serves as the current collector for the negative electrode. The positive electrode also comprises a thin layer of resin-bonded, porous, particulate lithium-metal-oxide composition bonded to a thin foil of aluminum which serves as the current collector for the positive electrode. Thus, the respective electrodes have been made by dispersing mixtures of the respective binders and active particulate materials in a suitable liquid, depositing the wet mixture as a layer of controlled thickness on the surface of a current collector foil, and drying, pressing, and fixing the resin-bonded electrode particles to their respective current collector surfaces. The positive and negative electrodes may be formed on conductive metal current collector sheets of a suitable area and shape, and cut (if necessary), folded, rolled, or otherwise shaped for assembly into lithium-ion cell containers with suitable porous separators and a liquid electrolyte. But such processing of the wet mixtures of electrode materials requires extended periods of manufacturing time. And the thickness of the respective active material layers (which limits the electrical capacity of the cell) is limited to minimize residual stress during drying of the electrode material.

The preparation and deposition of the wet mixtures of electrode materials on current collector foils is now seen as time-consuming, cell capacity limiting, and expensive. It is recognized that there is a need for a simpler and more efficient practice for making layers of electrode materials for lithium-ion battery cells.

In a related, commonly-owned, patent application, PCT (CN 2013) 085330, filed 16 Oct. 2013, titled “Making Lithium Secondary Battery Electrodes Using an Atmospheric Plasma,” methods were disclosed for making lithium secondary battery electrode structures using an atmospheric plasma to deposit particles of electrode materials onto a selected substrate surface for the electrode structure and to bond the deposited particles to the substrate surface of the electrode structure. When the electrode material was a conductive metal, such as aluminum or copper, used to form a current collector film for an electrode, particles of the conductive metal were deposited on a selected substrate using the disclosed atmospheric plasma process. And when the electrode materials were non-metallic particles for an active electrode material, such as silicon, graphite, or lithium titanate, the non-metallic material particles were preferably coated with a metal or mixed with metal particles prior to deposition on a cell member substrate using the atmospheric plasma.

There remains a need for further developments using atmospheric plasma technology in the manufacture of electrode members for lithium batteries.

### SUMMARY OF THE INVENTION

In practices of this invention, particles of an electrode composition for a lithium secondary battery cell and particles of a metallic binder/conductor material are co-deposited on a cell substrate member using separate (two or more) atmospheric plasma application nozzles or guns. A first atmospheric plasma nozzle, employed to form and conduct a gas-borne stream of solid particles of a selected active electrode material, is operated to heat and activate the particulate electrode material for deposition on a substrate surface. The substrate surface may be, for example, a flat side or face of a thin, porous separator layer or a surface of a metal current collector foil. A separate atmospheric plasma nozzle is operated to heat and activate a gas-borne stream of particles of a selected metallic binder/conductor material for merger with, and co-deposition with, the stream of active electrode material particles. In the case of the atmospheric plasma-activated binder/conductor particles, the plasma energy is used to form a stream of partially melted metal particles which may comprise some of the original metal particles in a part solid-part liquid state and some original particles which are converted to liquid droplets. In this way the partially melted metal particles are capable of adhering to the electrode material particles and, upon re-solidification of the metal particles, bonding the electrode material particles to each other and to a surface of a substrate. The proportions of the materials in the two (or more) flowing streams are controlled and directed so that the respective particles are mixed or merged and co-deposited in a porous, generally uniformly thick, particulate layer of pre-determined thickness on the intended surface of a selected cell substrate member.

The atmospheric plasma nozzles are movably mounted at a movable workstation for jointly forming the mixed-particle electrode layers. The positions and orientations of the two or more nozzles may be controlled and changed to aim each flowing stream of plasma-activated particles at the same coating area to achieve the mixing of the particles as their separate plasma-activated streams are co-deposited on the selected substrate. The formulation and uniformity (or non-uniformity) of the forming mixed-particle electrode layer can be controlled by the powder flow rates of the respective atmospheric plasma nozzles.

The deposition of the materials from the two or more plasma streams is accomplished such that a suitable proportion of the binder/conductor particles are momentarily partially melted to serve to bond the electrode material particles to each other in a porous layer and to bond the porous electrode material layer to the surface of the substrate layer. The applied coating of thus bonded particles of electrode material is preferably characterized by three or more layers of the active material particles so that the accumulated layers of electrode material particles form tortuous, non-straight, pore pathways through the coating layer. And the binder/conductor material also serves to provide appropriate electrical conductivity within and through the porous electrode layer. The composition of the electrode layer and its porosity may be varied throughout the thickness of the deposited material. The porosity of the electrode layer is provided and controlled for subsequent infiltration with a non-aqueous, liquid, lithium-ion containing electrolyte in an assembled cell structure.

The use of separate, but co-directed, atmospheric plasma streams to deposit lithium cell electrode materials enables the formation of anode layers and cathode layers from a surprisingly wide range of suitable compositions that are capable of receiving lithium ions (intercalating) from a liquid electrolyte and releasing lithium ions (de-intercalating) lithium ions into the electrolyte.

In accordance with practices of this invention, particles of an active electrode material are prepared having a suitable particle size range for use in forming an electrode layer comprising several layers of particles. For example, the electrode material particles may have particle sizes in the range of hundreds of nanometers to tens of micrometers, with characteristic particle sizes preferably in the range of about one micrometer to about fifty micrometers. And the total thickness of the electrode material amounts to three or more times the nominal diameters of the particles, typically up to about two hundred micrometers.

A few examples of suitable electrode materials for the anode (or negative electrode) of a lithium ion cell are graphite, silicon, alloys of silicon with lithium or tin, silicon oxides (SiOx), and lithium titanate. Examples of cathode (or positive electrode) materials include lithium manganese oxide, lithium nickel oxide, lithium cobalt oxide and other lithium-metal-oxides. One or more of these materials may be used in an electrode layer. A more complete list of suitable anode materials and cathode materials is presented in a following section of this specification.

Typically an elemental metal is applied in the form of sub-micron size particles for plasma deposition on surfaces of the particles of active electrode material. While such particles of elemental binder/conductive metal may be otherwise coated onto the particles of electrode material or mechanically mixed with them, in practices of this invention it is preferred that separate atmospheric plasma streams of the electrode particles and binder particles be co-directed to a cell substrate surface to mix the solid electrode material particles and the partly liquid metal particles as they arrive at the substrate surface.

The composition of the metal binder/electrical conductor is selected to be compatible with the electrochemical working potentials of the cathode or anode of a lithium secondary battery. In general, metals suitable as binder/conductors in lithium-ion anode electrodes include: copper, silver, and gold (Group IB of the periodic table), nickel, palladium, and platinum (Group VIII), and tin (Group IVA). The composition of the conductive metal is selected and used in an amount to partially melt in the atmospheric plasma and, when they engage the electrode material particles, to bond them as a porous layer to a current collector foil for lithium-secondary cell or to a porous separator layer for the cell. Upon re-solidification, the conductive metal provides binding sites that bond the electrode material particles to each other in a porous layer and to an underlying current collector or separator substrate. The conductive metal constituent is used in an amount to securely bond the active electrode material particles to the cell-member substrate as a porous layer that can be infiltrated with a liquid electrolyte to be used in an assembled lithium-ion cell. Further, the conductive metal also provides electrical conductivity to the deposited layer of electrode material. Typically, the particles of conductive metal may be applied in an amount of from about five weight percent to about sixty weight percent of the total weight of the composite of metal and active material constituent(s). In accordance with practices of this invention, the conductive metal/active electrode material particle composition consists exclusively of such metal particle site bound-active material for the electrode, free of any liquid vehicle or organic binder material. Similarly, and separately, particles of positive electrode materials, such as lithium-manganese-oxide, lithium-nickel-oxide, and/or lithium-cobalt-oxide are engaged and mixed with metal particles in an atmospheric plasma stream. Metals suitable as particle-site binder/conductors in lithium-ion cathode electrodes include: aluminum, indium, and thallium (Group IIIA), titanium, zirconium, and hafnium (Group IVB), nickel, palladium, and platinum (Group VIII), and silver and gold (Group IB). Preferably, sub-micron-size particles of the selected metal are co-deposited with particles of the active positive electrode material.

In preferred practices of the invention, an atmospheric plasma stream carrying particles of electrode material and an atmospheric plasma stream containing part-liquid, part-solid particles of binder/conductive material are co-directed against a moving substrate surface controlled at a suitable speed and in a suitable direction so as to deposit the active electrode material as a porous layer of binder/conductive metal-bonded particles adhering to the otherwise unheated substrate. While either, or both, of the plasma streams and lithium cell substrate member may be in motion during the deposition of the active electrode material and the binder material, it is generally preferred to fix the orientation of the plasma streams and move the substrate member(s) in the paths of the plasma streams. In many applications of the process, the electrode material layer will be deposited in one or more coating steps, the coating comprising several “layers” of particles with a total uniform coating thickness of up to about 200 micrometers. The thickness of the deposit of active electrode material usually depends on the intended electrical generating capacity of the cell being formed.

The use of co-directed, cooperating atmospheric plasma streams, intersecting in a common focal area, to deposit electrode materials on a surface of a cell substrate member enhances and simplifies the making of lithium-ion batteries and lithium-sulfur batteries. Different cell chemistries and designs can be built side-by-side, all in one work station without investing in a new production line, making changes easy and low cost. Several alternatives for coating and stacking can be proposed.

For example, a porous particulate cathode material coating may be deposited on an aluminum current collector foil, and then a porous separator layer can be placed on the cathode material coating, followed by coating of particulate anode material directly onto the opposing surface of the separator. A thin copper current collector layer may then be deposited on the porous anode material layer. Thus, a single cell unit is prepared with a selected sequence of plasma depositions and a mechanical placement of a separator layer. But the plasma depositions may thus be used to save weight and cost. The reverse order of formation of anode and cathode can be done as well. The use of an atmospheric plasma to deposit a current collector on a previously deposited electrode layer reduces Al and Cu foil usage, and reduces the weight and cost of the current collector layer. Low cost, thinner separators can now be used for weight and cost reduction further improving energy and power density. Thus, proposed plasma based coating and staking operations can be programmed for automation; cell fabrication can be truly on demand which makes product mix less costly.

The porous atmospheric plasma-deposited electrodes function upon suitable contact of the electrode material by the electrolyte and transfer of lithium into and from each electrode during the cycling of the cell.

In general, atmospheric plasma deposition practices of the invention may be conducted under ambient conditions and without preheating of either the substrate layer or the solid particles carefully supplied to their respective atmospheric plasma generators. Although both the active material particles and the binder particles are momentarily heated in the high temperature atmospheric plasma, they are typically deposited on the substrate material without heating the substrate from an ambient temperature to a temperature as high as 150° C. In some practices the applied coating may be cooled by a stream of cool air, or the like, to enhance re-solidification of the metal binder or to otherwise speedup processing.

Other objects and advantages of the invention will become apparent from the further illustrations of practices of the invention in the following sections of this specification.

### BRIEF DESCRIPTION OF THE DRAWINGS

FIG. 1 is an enlarged schematic illustration of the anode, separator, and cathode elements of a lithium-ion cell depicting an anode and a cathode, each consisting of a metal current collector carrying a porous layer of deposited conductive metal/active electrode material formed in accordance with the atmospheric plasma deposition process of this invention.

FIG. 2A is a schematic illustration, depicting a method of progressively and simultaneously applying sized active electrode material powder and smaller metal binder particles to a sequence of current collector substrates of predetermined shape, carried in organized rows on a movable conveyer flat belt working surface. A first atmospheric plasma nozzle (or gun) is supplied with active electrode material powder and directs a gas stream of the powder, activated in a suitable high energy plasma stream, to the surface of a selected current collector substrate on the conveyer belt. A second atmospheric plasma nozzle is supplied with binder metal powder and directs a suitably energized atmospheric plasma stream to the same location on the surface of the current collector. The two atmospheric plasma streams are energized, directed, and focused so that the smaller metal particles are at least partially melted and engage and coat the particles of active electrode material to bond the particles of active electrode material in a uniform electrode layer on the upper surface of the current collector film.

FIG. 2B is an idealized, schematic illustration of an individual particle of electrode material coated by the process illustrated in FIG. 2A with smaller, partially melted particles of the selected binder metal.

FIG. 2C is an idealized, schematic illustration of a layer of metal particle-coated, active electrode material particles (three particles deep) deposited by the process of 2A on the surface of the metal current collector film.

A like practice may be used for applying one or more layers of binder metal/active electrode material to a porous separator layer.

FIG. 3 is a schematic illustration of a manufacturing arrangement for using multiple atmospheric plasma nozzles to deposit anode material on copper current collector layers on a first conveyer belt, and to deposit cathode material on aluminum current collector layers on a second conveyer belt. The two electrode preparation conveyers are brought together for the assembly of an anode and a cathode on opposite sides of a porous separator in the manufacture of lithium-ion cell members. The assembled cell members, located on a third conveyer are removed from the work area. This figure illustrates a method of using several pairs of atmospheric plasma guns in the manufacture of a representative lithium-ion cell structure.

### DESCRIPTION OF PREFERRED EMBODIMENTS

Practices of this invention utilize groups of atmospheric plasma nozzles or guns to deposit particles of active materials for lithium-ion cells (or for lithium-sulfur cells) onto cell member substrates, such as prepared current collector foils, or previously plasma-deposited current collector layers, and separators. Preferably, particles of active cell material are deposited using an atmospheric plasma gun that is operated to suitably heat or activate the cell material as it is carried in air, nitrogen, or other suitable gas stream. And gas stream-borne particles of a binder/conductor metal are co-deposited with the electrode material using a separate atmospheric plasma gun that is operated to heat and partially melt the metal particles. The atmospheric plasma equipment does not comprise a vacuum chamber or a chamber pressurized above atmospheric pressure. The flow rates and the operations of the two plasma guns are managed to obtain suitable adhesion between the metal particles and active material particles and suitable adhesion of the deposited layer of the metal particles and active material particles with the substrate surface. The metal constituent also serves to provide electrical conductivity in the electrode layer. This is accomplished without causing thermal damage to the active material so as to maintain the intended capacity for lithium in the operation of the electrode. Thus, the plasma streams are managed to obtain a desired cohesion and adhesion between the particles of the electrode and to obtain intended electrode performance.

In some embodiments of the invention, it is useful to form a current collector layer (often just a thin metal layer) on a layer of bonded active material using an atmospheric plasma gun to heat and deposit, for example, a thin layer of aluminum or copper.

An active lithium-ion cell material is an element or compound which accepts or intercalates lithium ions, or releases or gives up lithium ions in the discharging and re-charging cycling of the cell.

In applications for making layered anode structures for lithium-ion battery electrodes, the active material particles useful in an atmospheric plasma deposition process with selected binder metal particles may, for example, be composed of:
a metal including Si, Sn, Sb, Ge, and Pb;
metal alloys and/or intermetallic compounds including CoₓCu₆₋ₓSn₅ (0≦x≦2), FeSn₂, Co₃Sn₂, CoSn, CoSn₂, Ni₃Sn₂, Ni₃Sn₄, Mg₂Sn, SnMx (M=Sb, Cd, Ni, Mo, Fe), MSi₂ (M=Fe, Co, Ca, Ni), Cu₂Sb, CoSb₂, FeSb₂, Zn₄Sb₃, CoSb₃, CoFe₃Sb₁₂, InSb;
metal oxides including SnOx, SiOx, PbOx, GeOx, CoOx, NiOx, CuOx, FeOx, PdOx, CrOx, MOx, WOx, and NbOx, and, additionally, CaSnO₃ and Al₂(MoO₄)₃;
lithium-metal oxides including Li₄Ti₅O₁₂, LiTi₂O₄, and LiTi₂(PO₄)₃;
metal sulfides including TiS₂ and MoS₂;
metal nitrides including Sn₃N₄, Ge₃N₄, Zn₃N₂, M₃N (M=Fe, Co, Cu, Ni), CrN, VN, CrₓFe₁₋ₓN, Li₃FeN₂, Li₃₋ₓMₓN (M=Co, Ni, Fe, Cu), and Li₇MnN₄);
metal phosphides including (VP₂, ZnP₂, CoP₃, MnP₄, CrP, Sn₄P₃, Ni₂P,
carbon including graphite, mesocarbon microbeads of graphite (MCMB), hard carbon, soft carbon, activated carbon, amorphous carbon; and
conductive polymers including polypyrrole and polyaniline.

In applications for making layered cathode structures the active materials useful in an atmospheric plasma deposition process with selected binder metal particles may be composed of:
metal oxides including VOx, MoOx, TiNb(PO₄)₃;
lithium metal oxides including LixMO₂ (M=Co, Ni, Mn, Cr, V), LixM₂O₄ (M=Co, Ni, Mn, Cr, V), LiCo₁₋ₓNiₓO₂, LiMn₂₋ₓMₓO₄ (M=Co, Ni, Fe, Cu, Cr, V), LiNiVO₄, LiCoₓMn_{y}Ni_{1-x-y}O₂, LiFePO₄, Li₃V₂(PO4)₃, Li₃FeV(PO₄)₃, LiFeNb(PO₄)₃, Li₂FeNb(PO₄)₃; and
metal sulfides, including NiS, Ag₄Hf₃S₈, CuS, FeS, and FeS₂.

An illustrative lithium-ion cell will be described, in which electrode members can be prepared using practices of this invention.

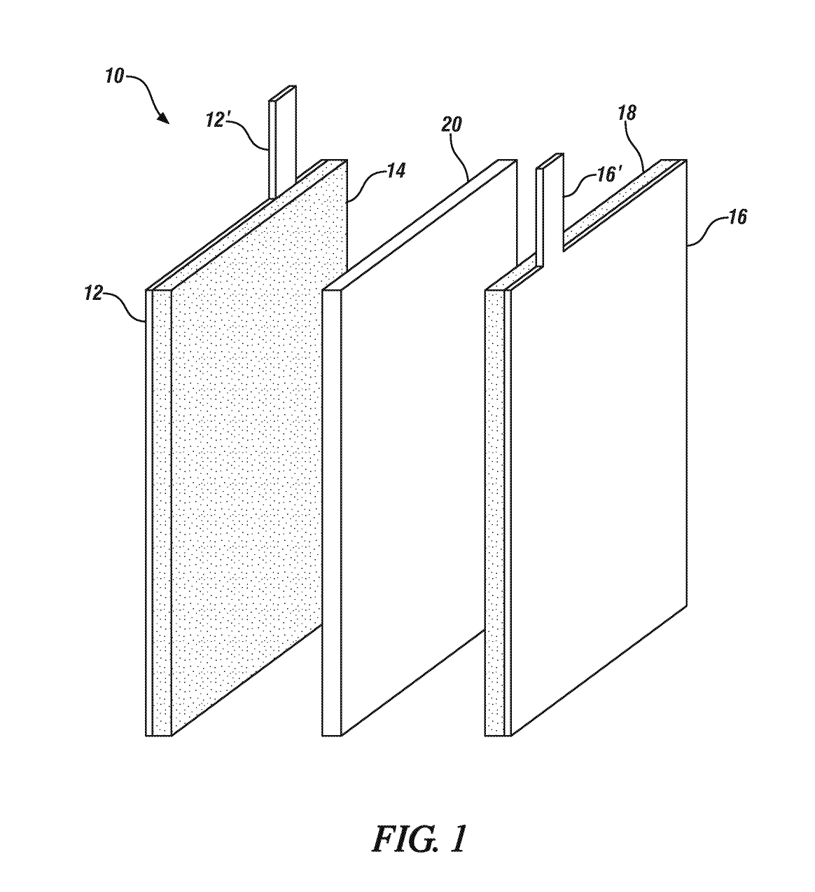

FIG. 1 is an enlarged schematic illustration of a spaced-apart assembly 10 of three solid members of a lithium-ion electrochemical cell. The three solid members are spaced apart in this illustration to better show their structure. The illustration does not include an electrolyte solution whose composition and function will be described in more detail below in this specification. Practices of this invention are typically used to manufacture electrode members of the lithium-ion cell when they are used in the form of relatively thin, layered structures.

In FIG. 1, a negative electrode comprises a relatively thin conductive metal foil current collector 12. In many lithium-ion cells, the negative electrode current collector 12 is suitably formed of a thin layer of copper or stainless steel. The thickness of metal foil current collector is suitably in the range of about five to twenty-five micrometers. The current collector 12 has a desired two-dimensional plan-view shape for assembly with other solid members of a cell. Current collector 12 is illustrated as rectangular over its principal surface, and further provided with a connector tab 12′ for connection with other electrodes in a grouping of lithium-ion cells to provide a desired electrical potential or electrical current flow.

Deposited on the negative electrode current collector 12 is a thin, porous layer of negative electrode material 14. As illustrated in FIG. 1, the layer of negative electrode material 14 is typically co-extensive in shape and area with the main surface of its current collector 12. The electrode material has sufficient porosity to be infiltrated by a liquid, lithium-ion containing electrolyte. The thickness of the rectangular layer of negative electrode material may be up to about two hundred micrometers so as to provide a desired current and power capacity for the negative electrode. As will be further described, the negative electrode material may be applied layer-by-layer so that one large face of the final block layer of negative electrode material 14 is bonded to a major face of current collector 12 and the other large face of the negative electrode material layer 14 faces outwardly from its current collector 12. In accordance with practices of this invention, the negative electrode material (or anode during cell discharge) is formed by using an atmospheric plasma deposition method, using two or more plasma guns, to deposit activated particles of anode material and activated metal particles in separate plasma streams as a mixed particles on a metallic current collector foil substrate. Methods for the preparation of the metal particle and anode material layer are presented below in this specification.

A positive electrode is shown, comprising a positive current collector foil 16 (often formed of aluminum or stainless steel) and a coextensive, overlying, porous deposit of positive electrode material 18. Positive current collector foil 16 also has a connector tab 16′ for electrical connection with other electrodes in other cells that may be packaged together in the assembly of a lithium-ion battery. The positive current collector foil 16 and its coating of porous positive electrode material 18 are typically formed in a size and shape that are complementary to the dimensions of an associated negative electrode. In the illustration of FIG. 1, the two electrodes are alike (but they do not have to be identical) in their shapes, and assembled in a lithium-ion cell with the major outer surface of the negative electrode material 14 facing the major outer surface of the positive electrode material 18. The thicknesses of the rectangular positive current collector foil 16 and the rectangular layer of positive electrode material 18 are typically determined to complement the negative electrode material 14 in producing the intended electrochemical capacity of the lithium-ion cell. The thicknesses of current collector foils are typically in the range of about 5 to 25 micrometers. And the thicknesses of the electrode materials, formed by this dry atmospheric plasma process are up to about 200 micrometers. Again, in accordance with practices of this invention, the positive electrode material (or cathode during cell discharge) is formed by an atmospheric plasma deposition method, using two or more plasma guns, to deposit activated particles of cathode material and activated metal particles in separate plasma streams as a mixed particles on a metallic current collector foil substrate. Methods for the preparation of the metal particle and cathode material layer are presented below in this specification. A thin porous separator layer 20 is interposed between the major outer face of the negative electrode material layer 14 and the major outer face of the positive electrode material layer 18. In many battery constructions, the separator material is a porous layer of a polyolefin, such as polyethylene or polypropylene. Often the thermoplastic material comprises inter-bonded, randomly oriented fibers of PE or PP. The fiber surfaces of the separator may be coated with particles of alumina, or other insulator material, to enhance the electrical resistance of the separator, while retaining the porosity of the separator layer for infiltration with liquid electrolyte and transport of lithium ions between the cell electrodes. The separator layer 20 is used to prevent direct electrical contact between the negative and positive electrode material layers 14, 18, and is shaped and sized to serve this function. In the assembly of the cell, the opposing major outer faces of the electrode material layers 14, 18 are pressed against the major area faces of the separator membrane 20. A liquid electrolyte is injected into the pores of the separator membrane 20 and electrode material layers 14, 18.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiCoO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and liquid solvent is selected for providing suitable mobility and transport of lithium ions in the operation of the cell. The electrolyte is carefully dispersed into and between closely spaced layers of the electrode elements and separator layers. The electrolyte is not illustrated in the drawing figure because it is difficult to illustrate between tightly compacted electrode layers.

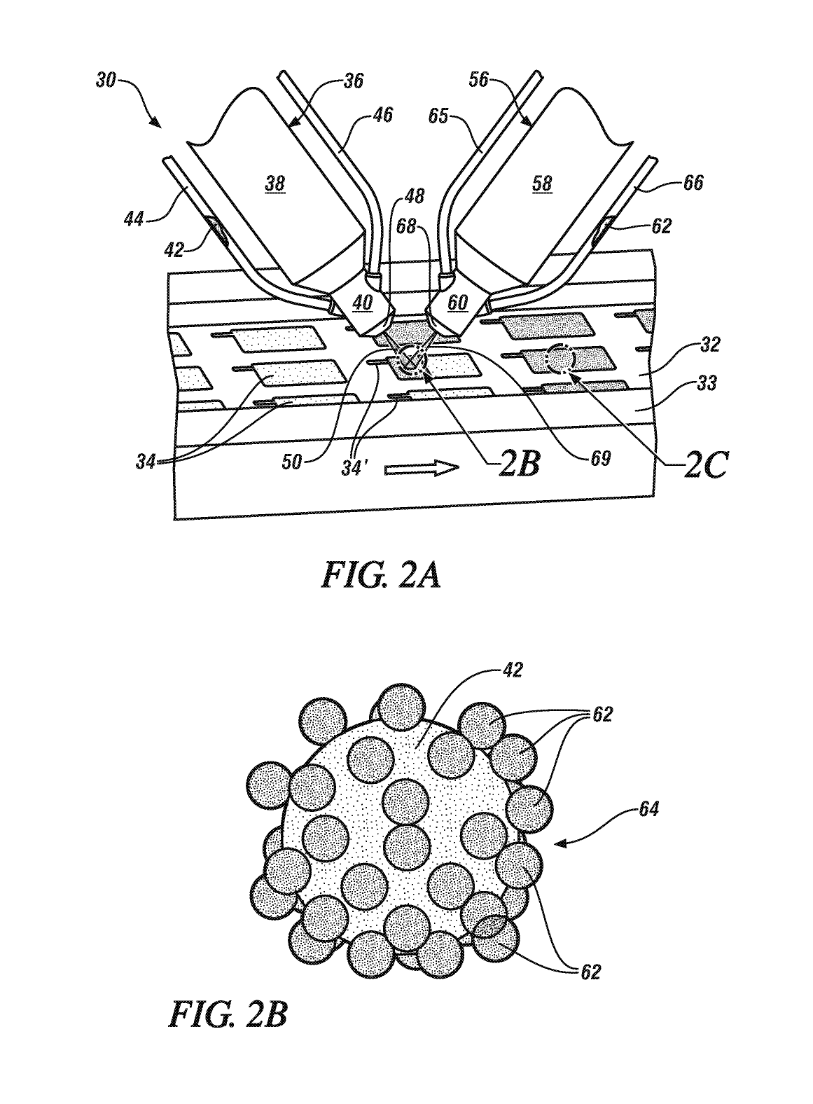

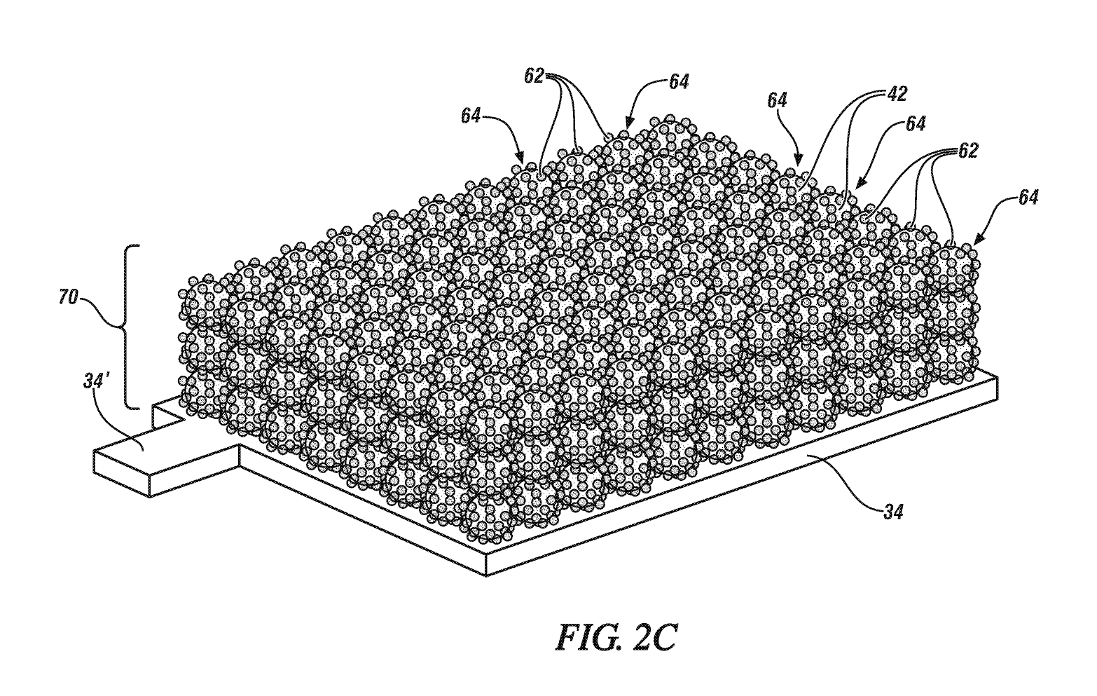

FIG. 2A is a schematic illustration depicting apparatus 30 and a method for progressively and simultaneously applying sized active electrode material powder and smaller metal binder particles to many previously formed current collector foil substrates 34 of predetermined shape, carried on a movable flat conveyer belt 32 working surface (moving left to right in the figure) within conveyer frame 33. In the example of FIG. 2A, the current collector substrates 34 are alike and may, for example, be formed of copper foil, about ten micrometers in thickness, to serve as anode current collectors. Each copper foil anode current collector 34 has an integral tab 34′ for electrical connection with other electrodes in a grouping of cells. The copper foil current collector substrates 34 are placed on conveyer belt 32, each with an exposed surface, in an organized pattern for coating on the surface with particles of anode material using a first atmospheric plasma nozzle 36 and particles of an elemental binder/conductor metal using a second atmospheric plasma nozzle 56.

First atmospheric plasma nozzle (or gun) 36 comprises an upstream round flow chamber 38 (shown in partly broken-off illustration) for the introduction and conduct of a flowing stream of suitable working gas, such as air, nitrogen, or an inert gas such as helium or argon. In this embodiment, this illustrative initial flow chamber 38 is tapered inwardly to smaller round flow chamber 40. Particles of electrode materials 42 are delivered through supply tubes 44, 46 (tube 44 is shown partially broken-away to illustrate delivery of the electrode particles 42) and are suitably introduced into the working gas stream in chamber 40 and then carried into a plasma nozzle 48 in which the air (or other working gas) is converted to a plasma stream 50 at atmospheric pressure. As the particles 42 enter the gas stream in chamber 40 they are dispersed and mixed in it and carried by it. As the stream flows through a downstream plasma-generator nozzle 48, the active anode material particles 42 are heated by the formed plasma to a plasma stream 50 at a deposition temperature. The momentary thermal impact on the active anode material particles may be a temperature up to about 3500° C. The particles 42 of active electrode material powder are thus activated in a suitable high energy plasma stream, and directed to the upper surface of a selected current collector substrate 34 on the conveyer belt 32.

A second atmospheric plasma nozzle 56 is supplied with small particles of binder metal and directs a suitably energized atmospheric plasma stream to the same location on the surface of the current collector 34. Second atmospheric plasma nozzle 56 comprises an upstream round flow chamber 58 (shown in partly broken-off illustration) for the introduction and conduct of a flowing stream of suitable working gas, such as air, nitrogen, or an inert gas such as helium or argon. Again, this illustrative initial flow chamber 58 is tapered inwardly to smaller round flow chamber 60. Particles of binder/conductive metal 62 are delivered through supply tubes 65, 66 and are suitably introduced into the working gas stream in chamber 60 and then carried into a plasma nozzle 68 in which the air (or other working gas) is converted to a plasma stream 69 at atmospheric pressure. As the metal particles 62 enter the gas stream they are dispersed and mixed in it and carried by it. As the stream flows through a downstream plasma-generator nozzle 68, the metal particles 62 are heated by the formed plasma to a plasma stream 69 to a deposition temperature. The metal particles 62 are thus activated in a suitable high energy plasma stream 69, and also directed to the same upper surface of a selected current collector substrate 34 on the conveyer belt 32. The energizing or activation of the metal particles 62 in their plasma stream 69 may be different (sometimes a lower level of activation) than the activation of the anode particles (or other non-metallic electrode particles) in their separate plasma stream.

The two atmospheric plasma streams are energized, directed, and focused in a focal area so that the smaller metal particles 62 are at least partially melted and engage, mix with, and coat the particles of active anode material 42 to bond the particles of active anode material 42, in a uniform electrode layer on the upper surface of the current collector film. The focal area of the two atmospheric plasma streams is circled, illustrated, and indicated as region 2B from which the illustration of composite particles 64 in FIG. 2B is taken.

FIG. 2B is an idealized, schematic illustration of a composite 64 of an individual particle 42 of anode material (or other electrode material) coated with smaller, momentarily partially melted particles 62 of the selected binder metal. The composite 64 of the anode particle 42 and metal particles 62 is representative and schematically illustrative of the co-deposited electrode material formed on substrate surfaces, such as current collector surfaces or separator surfaces, in embodiments of this invention.

FIG. 2C is an idealized, schematic illustration of a layer 70 of the composites 64 of metal particle-coated, active electrode material particles (three particles deep) on the surface of the metal current collector film 34. FIG. 2C is characterized as idealized because the particles of active electrode material 42 are more randomly distributed in particle layers in the plasma deposition process. In general, the main surface area of the current collector 34, but not the connection tab 34′, is coated with the composite 64 of electrode particles 42 and metal particles 62.

The plasma nozzles 36, 56 depicted in FIG. 2A are supported, and positioned and angled to progressively and sequentially deposit their respective particulate materials on the several current collector foils 34 placed on the moving conveyer 32. The nozzle of the plasma apparatus may be sized to provide a predetermined plasma spray area or pattern. And more than one nozzle may be used to a desired plasma spray pattern for the particles to be deposited. The plasma nozzles 36, 56 may be carried on a robot arm or other supporting mechanism and the control of the respective plasma generations and the movement of the robot arm are managed under control of a programmed computer. In many embodiments, it is preferred to determine and fix the positions of the plasma spray nozzles and move substrates to be coated with respect to the nozzles.

Such plasma nozzles for this application are commercially available and may be carried and used on robot arms, under multi-directional computer control, to coat the surfaces of each planar substrate for a lithium-ion cell module. Multiple nozzles may be required and arranged in such a way that a high coating speed may be achieved in terms coated area per unit of time.

The plasma nozzle typically has a metallic tubular housing which provides a flow path of suitable length for receiving the flow of working gas and dispersed particles of electrode material (or of metal binder/conductor particles) and for enabling the formation of the plasma stream in an electromagnetic field established within the flow path of the tubular housing. The tubular housing terminates in a conically tapered outlet, shaped to direct the shaped plasma stream toward an intended substrate to be coated. An electrically insulating ceramic tube is typically inserted at the inlet of the tubular housing such that it extends along a portion of the flow passage. A stream of a working gas, such as air, and carrying dispersed particles of metal particle-coated electrode material, is introduced into the inlet of the nozzle. The flow of the air-particle mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a suitable generator at a frequency in the 0.1 hertz to gigahertz range and to a suitable potential of a few kilovolts. Plasma generation technology such as corona discharge, radio wave, and microwave sources, and the like, may be employed. The metallic housing of the plasma nozzle is grounded. Thus, an electrical discharge can be generated between the axial pin electrode and the housing. No vacuum chamber is used.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/particulate electrode material stream to the outlet of the nozzle. A reactive plasma of the air and electrode material mixture is formed at a relatively low temperature. A copper nozzle at the outlet of the plasma container is shaped to direct the plasma stream in a suitably confined path against the surfaces of the substrates for the lithium-ion cell elements. The energy of the plasma may be determined and managed for the material to be applied. In many embodiments of this invention, the energy of the atmospheric plasma used to supply and direct the particles of electrode material will be higher than atmospheric plasmas used to supply and direct metal binder/conductor particles or particles of metal used to deposit a current collector layer.

In the example illustrated in FIGS. 2A-2C, composites 64 of metal particle-bonded particulate electrode materials were deposited on previously formed current collectors 34 using a pair of atmospheric plasma nozzles or guns 36, 56. Many other practices using multiple plasma generators may be employed in forming lithium-ion cell members.

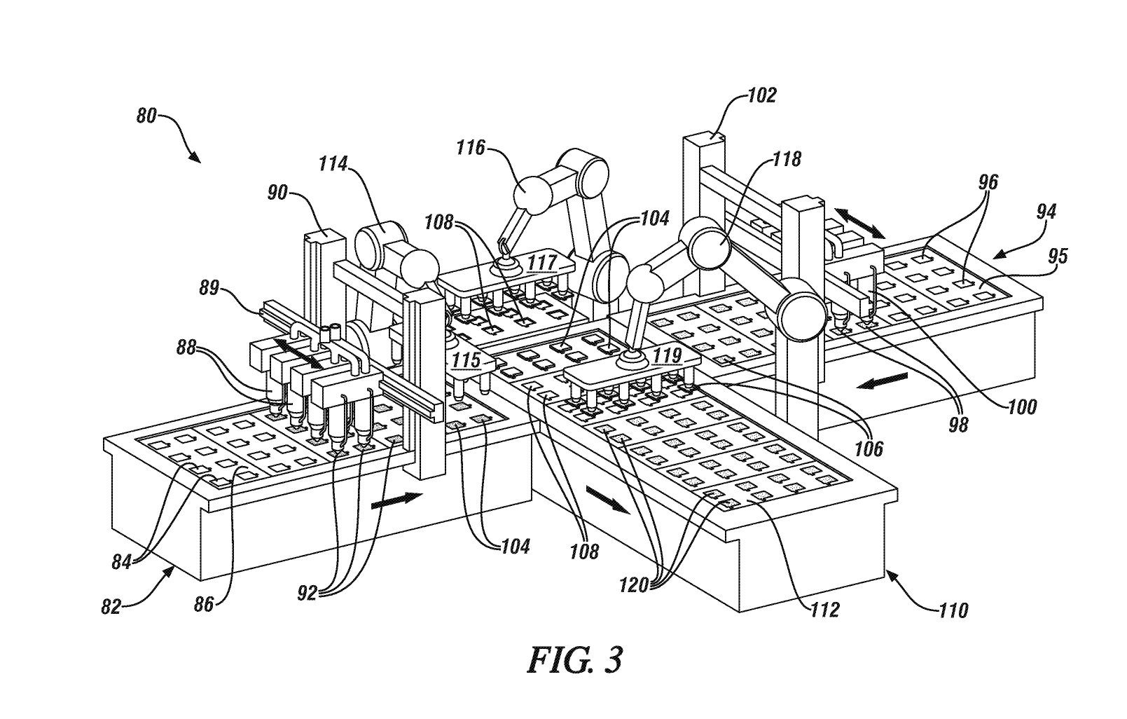

FIG. 3 is a schematic illustration of a manufacturing arrangement 80 for using separate conveyer lines to (i) separately prepare anode material layers on copper or stainless steel current collectors, (ii) cathode material layers on aluminum or stainless steel current collectors, and (iii) to assemble the anode and cathodes on opposite sides of a porous separator member.

In this example, with reference to the manufacturing arrangement 80 of FIG. 3, conveyer system 82 (moving left to right in the figure) carries a group of identical preformed copper current collector foils 84 arranged in evenly spaced, transverse rows on conveyer belt 86. Multiple pairs of atmospheric plasma nozzles 88 are movably supported on crossbar 89 of vertical structure 90, and controlled and powered (by means not illustrated in FIG. 3) to co-deposit composite anode material 92 on copper current collector foils 84. In order to simplify the illustration on FIG. 3, a pair of a atmospheric plasma nozzles, one for depositing particles of active anode material and one for depositing particles of binder/conductive metal particles, is represented by each image of a plasma nozzle 88. Accordingly, in this example, eight pairs of atmospheric plasma nozzles 88 are used to simultaneously apply a plasma stream of particles of anode material and a separate stream of particles of binder metal as composite anode material 92 to two rows of four copper foils 84. The pairs of atmospheric plasma nozzles 88 are movable transversely on crossbar 89 of vertical support structure 90 complementary to the controlled rate of advance of belt 86. The energy levels of the respective plasma nozzles are controlled (by computer controls, not shown) and the movement of the nozzles is controlled to apply identical, uniform coatings of composite anode material 92 on the copper current collector foils 84.

A like conveyer system 94 with a conveyer belt 95 (moving right to left in FIG. 3 is used to deposit composite cathode material 98 on aluminum current collector foils 96. Conveyer system 94 carries a group of identical preformed aluminum current collector foils 96 arranged in evenly spaced, transverse rows on conveyer belt 95 of conveyer system 94. Multiple pairs of atmospheric plasma nozzles 100 are movably supported on vertical support structure 102, and controlled and powered (by means not illustrated in FIG. 3) to co-deposit composite cathode material 98 on aluminum current collector foils 96. Again, in this example, eight pairs of atmospheric plasma nozzles 100 are used to simultaneously apply a plasma stream of particles of cathode material and a separate stream of particles of binder metal as composite cathode material 98 to two rows of four aluminum foils 96. The pairs of atmospheric plasma nozzles 100 are movable transversely on vertical support structure 102 to the controlled rate of advance of belt system 94. Again, the energy levels of the respective plasma nozzles 100 are controlled (by computer controls, not shown) and the movement of the nozzles is controlled to apply identical, uniform coatings of composite cathode material 98 on the aluminum current collector foils 96.

The flow of anode materials 84, 92 (now anodes 104) and the cathode materials 96, 98 (now cathodes 106) on their respective conveyer systems 82, 94 are brought together for the assembly of a group of anodes 104 (eight in this illustration) and a group of cathodes 106 (eight in this illustration) on opposite sides of porous separators 108 in the manufacture of lithium-ion cell members.

Conveyer system 110 with conveyer belt 112 is used in support and removal of an assembly of an anode 104 and a cathode 106 on opposite sides of a separator 108 to form a lithium-ion cell 120 (a group of cells 120 are arranged in rows of four on conveyer belt 112 which is from back to front of conveyer system 110.

Computer controlled robot 114, carrying an eight-hand lifting mechanism 115, lifts eight anodes 104 from belt 86 and places them in two rows of four anodes at the rearward end of belt 112 (as viewed in FIG. 3). Computer controlled robot 116, carrying an eight-hand lifting mechanism 117, lifts eight separators 108 from a separator stack and places the separators 108 on top of the eight anodes 104 just placed on belt 112. And, then, computer controlled robot 118, carrying an eight-hand lifting mechanism 119, lifts eight cathodes 106 from belt 97 and places the cathodes on the upper faces of the eight separators on belt 112. Each stack of anode 104, separator 108, and cathode 106 constitutes a lithium cell 120 assembly of the dry elements of the cell. A suitable clamping or holding member or device (not illustrated in the drawing figure) may be required to temporarily hold together each assembly of cell members until they are ready for placement in a pouch or other cell container. As this manufacturing and assembly method progresses, rows of assembled cells are moved on conveyer belt 112 to the front end of computer system 110 for removal relocation for further cell assembly. For example, a group of a predetermined number of such cells may be put together with appropriate connection of current collector members and placed in a pouch or other container for infiltration with a liquid electrolyte.

Accordingly, groups of suitably supported, energized, and directed atmospheric plasma devices may be used in combination with suitable workpiece supporting, holding, and moving equipment in the efficient and low-cost manufacture of thin electrode members for assembly into lithium-ion cells and lithium-sulfur cells. The plasma devices may be used to deposit electrode and metal binder materials on the surfaces of separators or on the surfaces of preformed current collector substrates. The current collector substrates may be formed using a plasma device. In addition to applying electrode materials to individual, pre-sized cell substrate members, groups of plasma nozzles may be used to coat electrode materials in roll-to roll operations for high throughput, followed by cutting or slitting of the rolls into individual sized electrodes for assembly into cells.

Following is a description of another manufacturing practice for making lithium-ion cells using multiple atmospheric plasma nozzles. In this embodiment, the manufacturing operation starts with a grouping of thin porous separators, with two principal sides, arranged on a suitable supporting surface, such as a conveyer belt. The separators are placed such that they lie on one principal side with the other side facing upwardly. And they are arranged, and moved if necessary, for access by a series of atmospheric plasma deposition equipment.

In a first series of coating steps, the upper surfaces of the thin porous separator layers are uniformly, and substantially co-extensively, coated with a combination of anode material and binder metal particles using pairs of atmospheric plasma equipment. It may be necessary to move the separator surface with respect to the plasma deposition equipment to obtain a uniform coating over the area of the separator surface. The atmospheric plasma coating deposit does not get hot enough to damage a polymeric separator (if that is the selected separator material), but the applied composite anode material adheres to the surface of the separators. The anode-material coated separators may then be moved to another atmospheric plasma nozzle for deposition of a thin layer of suitable current collector metal, such as a film of copper, over the surface of the previously deposited anode material.

The separators, coated with composite anode material and a current collector layer are turned over, if necessary, and are then moved to another set of plasma nozzle(s). The uncoated sides of the separators are coated with cathode material and binder metal particles. The separators may be moved again and an aluminum current collector layer is deposited by atmospheric plasma on the exposed surface of the metal particle-bonded cathode material layer. The, thus prepared, cell units are ready for stacking, anode face to anode face and cathode face to cathode face in a lithium-ion battery module.

In another embodiment, the manufacturing operation starts with a grouping of thin porous separators that are suitably positioned and aligned. For example, the separators may be vertically aligned and spaced apart for access by groups of plasma guns or nozzles. Composite anode material and composite cathode material are applied to opposite sides of the separators at the same time using suitably designed plasma equipment. Following this time-saving step of depositing metal particle-electrode material composites to opposing separator surfaces at the same time, the respective current collector layers may be applied simultaneously. The electrode-material coated separators may then be moved to another set of atmospheric plasma nozzles so that a copper current collector layer and an aluminum current collector layer can be deposited by atmospheric plasma on the opposing exposed surfaces of the metal particle-bonded anode and cathode material layers, respectively.

Thus, methods of using groups of atmospheric plasma application nozzles or devices have been provided to form layered electrode materials and current collectors for working electrodes and reference electrodes in lithium-ion cells. The plasma method enables the formation of working material layers of up to about two hundred micrometers in thickness to increase the capacity of the electrodes. And the process avoids the use of extraneous binders of polymers and the need for wet process application of electrode materials to their current collector substrates.

It is recognized that the use of an atmospheric plasma may also be utilized in forming anode materials for lithiated silicon-sulfur secondary batteries. Lithiated silicon-sulfur cells typically comprise a lithiated silicon-based anode, a lithium polysulfide electrolyte, a porous separator layer and a sulfur-based cathode. A composite layer of metal binder particles and silicon based materials, including, for example, silicon, silicon alloys, and silicon-graphite composites, up to about 200 microns in thickness is deposited on a metal current collector in the formation of an anode layer. Atmospheric plasma deposition processes, like those described for the preparation of layered electrode members of lithium-ion cells may be used in making analogous electrode structures for lithiated silicon-sulfur cells.

The examples that have been provided to illustrate practices of the invention are not intended as limitations on the scope of such practices.

1. A method of forming an electrode for a lithium battery cell, the method comprising:
forming a first gas-carried stream of atmospheric plasma-activated particles of an electrode material for the lithium battery cell;
forming a second gas-carried stream of atmospheric plasma-activated metal particles in which at least some of the metal particles are partially melted in the plasma-activated second gas stream, the partially-melted metal particles being characterized by the presence of some part solid-part liquid metal particles and/or liquid metal droplets;
simultaneously co-directing the first stream and the second stream of atmospheric plasma-activated particles toward a surface of a lithium battery cell member, the cell member being in ambient air with its surface positioned to be impacted by the co-directed first and second streams of plasma activated particles, the co-directed streams of particles forming a deposited coating on the surface, the deposited coating initially comprising particles of electrode material in porous overlying layers and with intermixed partially-melted metal particles, the partially-melted metal particles cooling and re-solidifying in the deposited coating such that the particles of electrode material and re-solidified particles of metal are bonded to each other and the deposited coating of layered particulate electrode material is bonded to the surface of the cell member substrate as an electrode for a lithium battery cell.

2. A method of forming an electrode for a lithium battery cell as recited in claim 1 in which the coating of particles of electrode material is deposited on a flat surface of a non-electrode cell member.

3. A method of forming an electrode for a lithium battery cell on a cell member surface as recited in claim 1 in which the first and second streams of atmospheric plasma activated particles are co-directed and maintained in fixed paths in which the streams are brought together and mixed at a focal area, and a surface of the cell member is moved through the focal area to enable the co-directed streams to apply a deposited coating over a selected surface area of the cell member.

4. A method of forming an electrode for a lithium battery cell on a cell member surface as recited in claim 1 in which co-directed first and second streams of atmospheric plasma activated particles are brought together and mixed at a focal area, and the streams and focal area are moved together to apply a deposited coating of electrode material particles over a selected surface area of the cell member.

5. A method of forming an electrode for a lithium battery cell as recited in claim 1 in which the deposited coating is cooled to promote re-solidification of the partially-melted metal particles.

6. A method of forming an electrode for a lithium battery cell as recited in claim 1 in which the cell member is a sheet of porous separator material for the lithium battery cell or is a metal current collector for an electrode for the lithium battery cell.

7. A method of forming an electrode for a lithium battery cell as recited in claim 1 in which the particles of electrode material used in forming the first gas-carried particle stream have an average dimension in the range of about one micrometer to fifty micrometers and the metal particles used in forming the second gas-carried particle stream have a smaller average dimension.

8. A method of forming an electrode for a lithium battery cell as recited in claim 1 in which the thickness of the applied layered particulate electrode material is up to about two hundred micrometers and is at least three times the average dimension of the particles of electrode material.

9. A method of forming an electrode for a lithium battery cell as recited in claim 1 in which the particles of electrode material are selected for an anode of the lithium battery cell and the metal particles are selected to be electrochemically compatible with the anode particles in the lithium battery cell.

10. A method of forming an electrode for a lithium battery cell as recited in claim 1 in which the particles of electrode material are selected for a cathode of the lithium battery cell and the metal particles are selected to be electrochemically compatible with the cathode particles in the lithium battery cell.

11. A method of forming an electrode for a lithium battery cell as recited in claim 1 in which a first combination of first and second gas-carried particle streams of atmospheric plasma-activated particles is used to form a lithium battery cell anode layer comprising an anode material electrode layer on an anode current collector foil and a second combination of first and second gas carried-particle streams of atmospheric plasma-activated particles is used to form a lithium battery cell cathode layer comprising an cathode material electrode layer on a cathode current collector foil; and
the lithium battery anode layer is placed on one face of a sheet of porous separator material for a lithium battery cell with the anode material electrode layer in contact with the separator face, and the lithium battery cathode layer is placed on the opposite face of the sheet of the porous separator material with the cathode material electrode layer in contact with the separator face.

12. A method of forming an electrode for a lithium battery cell as recited in claim 1 in which a first combination of first and second gas-carried particle streams of atmospheric plasma-activated particles is used to form a lithium battery cell anode material layer on one face of a sheet of porous separator material for a lithium battery cell and a second combination of first and second gas-carried particle streams of atmospheric plasma-activated particles is used to form a lithium battery cell cathode material layer on the opposite face of a sheet of porous separator material for a lithium battery cell; and, subsequently,
a gas-carried stream of atmospheric plasma-activated metal particles is deposited as an anode current collector layer on the anode material layer on the separator face and another gas-carried stream of atmospheric plasma-activated metal particles is deposited as a cathode current collector layer on the cathode material on the opposite face of the separator layer.

13. A method of forming an electrode for a lithium battery cell as recited in claim 11 in which two or more adjacently positioned combinations of first and second combinations of gas-carried particle streams of atmospheric plasma-activated particles are used to concurrently form lithium battery cell anode layers on adjacently moving anode current collector foils;
two or more adjacently positioned combinations of first and second combinations of gas-carried particle streams of atmospheric plasma-activated particles are used to concurrently form lithium battery cell cathode layers on adjacently moving cathode current collector foils; and
pairs of the two or more thus formed anode and cathode members are concurrently placed on opposite sides of porous separators.

14. A method of forming an electrode for a lithium battery cell as recited in claim 12 in which lithium battery cathode material layers, cathode current collector layers, lithium cell battery anode material layers, and anode current collector layers are concurrently applied to the faces of two or more sheets of porous separator materials using two or more combinations of atmospheric plasma generation devices.

15. A method of forming electrodes for lithium battery cells comprising:
using a gas-carried stream of atmospheric plasma-activated lithium cell anode material particles and a second gas-carried stream of atmospheric plasma-activated, partially melted metal particles, that are electrochemically compatible with the anode material particles, in combination with a gas-carried stream of atmospheric plasma-activated lithium cell cathode material particles and a second gas-carried stream of atmospheric plasma-activated, partially melted metal particles, that are electrochemically compatible with the cathode material particles, to concurrently form a particulate, metal particle-bonded, anode material coating as an anode on a lithium cell member surface and a particulate, metal particle-bonded cathode material coating as a cathode on a lithium cell member substrate.

16. A method of forming electrodes for lithium battery cells as recited in claim 15 in which the anode is formed on a current collector for an anode and the cathode is concurrently formed on a current collector for a cathode; and
the anode-anode current collector and cathode-cathode current collector are placed on opposite sides of a separator for a lithium battery cell as part of an continuing lithium battery cell assembly process.

17. A method of forming electrodes for lithium battery cells as recited in claim 15 in which the anode is formed directly on one face of a porous separator for a lithium battery cell, the separator having opposing faces, and the cathode is concurrently formed directly on the opposing face of the separator.

18. A method of forming electrodes for lithium battery cells as recited in claim 17 in which an anode current collector is formed on the anode and a cathode current collector is concurrently formed on the cathode as part of a continuing battery assembly process.

19. A method of forming electrodes for lithium battery cells as recited in claim 15 in which the particles of the anode and cathode materials have average dimensions in the range of about one micrometer to fifty micrometers and their respective metal particles have smaller average dimensions.

20. A method of forming electrodes for lithium battery cells as recited in claim 19 the thicknesses of the formed anode and cathodes are not necessarily the same but each electrode has a thickness up to about two hundred micrometers and the thickness of each electrode is at least three times the maximum average dimension of its particulate electrode material.
